(19) United States
(12) Patent Application Publication
(10) Pub. No.: US 2017/0045232 A1
(43) Pub. Date: Feb. 16, 2017

(54) MICROWAVE OVEN

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Feina ZHANG, Foshan (CN); Xiangwei TANG, Foshan (CN); Xiantao DU, Foshan (CN)

(21) Appl. No.: 15/304,444

(22) PCT Filed: Aug. 29, 2014
(86) PCT No.: PCT/CN2014/085593

§ 371 Date: Oct. 14, 2016

(30) Foreign Application Priority Data
Apr. 24, 2014 (CN) 201420205466

(51) Int. Cl. F24C 7/08; H05B 6/72; H05B 6/68

(52) U.S. Cl. CPC F24C 7/08; H05B 6/68; H05B 6/72

(57) ABSTRACT

The present invention provides a microwave oven, including a cooking cavity, a microwave source, a controller and a first isolator, wherein the controller is connected to the microwave source, for controlling the power of the microwave source; and the first isolator is provided with a first input port, a first output port and a first isolation port, the first input port being connected to the microwave source, the first output port being connected to the cooking cavity, and the first isolation port being connected with a load.

### CROSS-REFERENCE TO RELATED APPLICATIONS

This application is the national phase entry of international patent application No. PCT/CN2014/085593 filed on Aug. 29, 2014, the disclosure of which is hereby incorporated herein by reference in its entirety for all purposes.

### STATEMENT REGARDING FEDERALLY SPONSORED RESEARCH OR DEVELOPMENT

Not Applicable.

### BACKGROUND

Technical Field

The present invention relates to the field of household appliances, and in particular, to a microwave oven.

Background of the Invention

Microwave ovens are common appliances used for heating or cooking, with the principle of making water molecules of food generate high frequency oscillation by microwaves to heat or cook the food by heat generated by friction. With the development of the semiconductor microwave technology, semiconductor microwave ovens employing semiconductor microwave generators in place of magnetrons to generate the microwaves have emerged. A microwave source of the existing semiconductor microwave oven mainly adopts the source amplification principle or the LDMOS (laterally diffused metal oxide semiconductor) oscillation principle, and the amplified microwaves are exported from microwave output port, and through connection with an antenna or probe or other feed-in device, are directly fed into cooking cavity. However, in such a manner of directly feeding the amplified microwaves into the cavity, microwaves will be reversely transmitted to the microwave source directly, which affects the normal work of the microwave source, and if the microwaves transmitted back to the microwave sources are too large, the microwave source could be even burnt out.

### SUMMARY

The present invention aims at solving at least one of the technical problems in the prior art.

To this end, the object of the present invention is to provide a microwave oven, which can isolate the reflection power and effectively guarantee the service life of a microwave source.

To achieve the above object, the present invention provides a microwave oven, including a cooking cavity; a microwave source; a controller, which is connected to the microwave source, for controlling the power of the microwave source; and a first isolator, which is provided with a first input port, a first output port and a first isolation port, the first input port being connected to the microwave source, the first output port being connected to the cooking cavity, and the first isolation port being connected with a load.

According to the microwave oven provided by the present invention, since the first isolator is arranged between the microwave source and the cooking cavity, the matching between the microwave source and the cooking cavity is optimized, the first isolation port of the first isolator is connected with the load, and when amplified microwaves are reversely transmitted by the cooking cavity, the reversely transmitted microwaves will be consumed by the load connected with the first isolator, thereby avoiding the problem that the microwave source is burnt out because the reversely transmitted microwaves are too large and guaranteeing the service life of the microwave source, and thus the product quality is improved.

In addition, the microwave oven provided by the present invention further has the following additional technical features:

According to one embodiment of the present invention, the load is a resistor, one end of the resistor being electrically connected with the first isolation port, and the other end of the resistor being grounded.

The resistor is small in volume and low in cost, occupies no internal space of the microwave oven and does not increase the production cost of the microwave oven, and moreover, the resistor can effectively consume the microwaves reversely transmitted by the cooking cavity, thereby avoiding the problem that the microwave source is burnt out because the reversely transmitted microwaves are too large, and guaranteeing the service life of the microwave source.

According to one embodiment of the present invention, a first feed-in device is arranged on the cooking cavity, and the first output port is communicated with the cooking cavity through the first feed-in device.

Due to the arrangement of the microwave feed-in device, the connection between the isolator and the cooking cavity is simple and convenient, and meanwhile, the transmission reliability of microwave signals is effectively guaranteed.

According to one embodiment of the present invention, the microwave oven further includes a second isolator, wherein the second isolator is provided with a second input port, a second output port and a second isolation port, and a second feed-in device is further arranged on the cooking cavity; the second input port is connected to the first isolation port, the second output port is communicated with the cooking cavity through the second feed-in device, and one end of the resistor is connected with the second isolation port.

The amplified microwaves are fed into the cooking cavity after passing through the first isolator, at this time, the microwaves reversely transmitted by the cooking cavity are fed into the cooking cavity again by the second isolator, so the utilization rate of the microwaves is effectively improved, and the microwaves reversely transmitted by the cooking cavity again are consumed by the resistor connected with the isolation port of the second isolator, thereby effectively avoiding the problem that the microwave source is burnt out because the reversely transmitted microwaves are too large, and guaranteeing the service life of the microwave source.

According to one embodiment of the present invention, the microwave oven further includes a detector, which is connected with the first isolation port, for detecting microwave signal strength output by the first isolation port and feeding back a detection result to the controller.

The detector detects the microwave signal strength output by the first isolation port and sends the detection result to the controller, and the controller adjusts the voltage or frequency or other parameter of the microwave source according to the received detection result, so the matching between the microwave source and the cooking cavity is optimized.

According to one embodiment of the present invention, the detector includes a coupler, which is connected with the first isolation port.

The coupler has the advantages of strong anti-jamming capability, high sensitivity and the like, so the accuracy of the detection result of the detector is effectively guaranteed.

According to one embodiment of the present invention, both of the first feed-in device and the second feed-in device are welded or clamped or screwed on the cooking cavity.

The welding or clamping or screwing has good connection strength, so the connection strength of the first feed-in device and the second feed-in device with the cooking cavity is effectively guaranteed.

According to one embodiment of the present invention, both of the first feed-in device and the second feed-in device are probes.

According to one embodiment of the present invention, both of the first feed-in device and the second feed-in device are antennas.

The antennas or the probes have the advantage of high efficiency, so the microwave transmission efficiency can be effectively improved.

The additional aspects and advantages of the present invention will be given in the description below, and a part thereof will become apparent from the description below or is understood through the practice of the present invention.

### BRIEF DESCRIPTION OF THE DRAWINGS

The aforementioned and/or additional aspects and advantages of the present invention will become apparent and understandable in the description in combination with accompany drawings below, wherein:

FIG. 1 is a schematic diagram of a first local structure of a microwave oven according to one embodiment of the present invention;

FIG. 2 is a schematic diagram of a second local structure of a microwave oven according to one embodiment of the present invention;

FIG. 3 is a schematic diagram of a third local structure of a microwave oven according to one embodiment of the present invention.

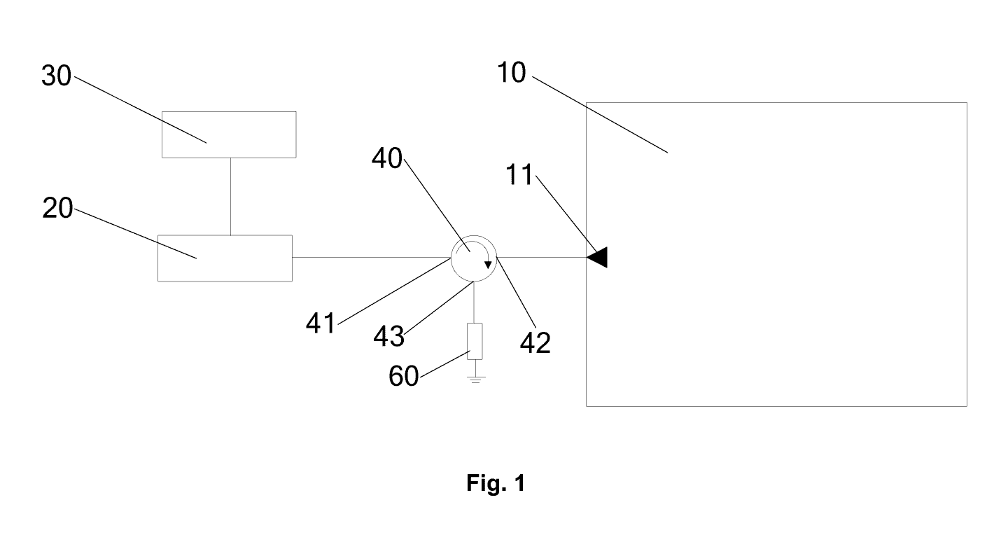

The corresponding relation of reference signs in FIGS. 1 to 3 and component names is as follows: 10: cooking cavity, 11: first feed-in device, 12: second feed-in device, 20: microwave source, 30: controller, 40: first isolator, 41: first input port, 42: first output port, 43: first isolation port, 50: second isolator, 51: second input port, 52: second output port, 53: second isolation port, 60: resistor, 70: detector.

### DETAILED DESCRIPTION

In order that the aforementioned objects, features and advantages of the present invention can be understood more clearly, a further detailed description of the present invention will be given below in combination with accompanying drawings and specific embodiments. It should be noted that the embodiments of the present application and the features in the embodiments can be combined with each other without conflict.

A lot of specific details are set forth in the description below to fully understand the present invention, however, the present invention can also be implemented in other manners different from those described herein, and thus the protection scope of the present invention is not limited to the specific embodiments disclosed below.

A microwave oven provided by some embodiments of the present invention will be described below with reference to FIGS. 1 to 3.

As shown in FIG. 1, the microwave oven provided by some embodiments of the present invention includes: a cooking cavity 10, a microwave source 20, a controller 30 and a first isolator 40, wherein the controller 30 is connected to the microwave source 20, for controlling the power of the microwave source 20; and the first isolator 40 is provided with a first input port 41, a first output port 42 and a first isolation port 43, the first input port 41 being connected to the microwave source 20, the first output port 42 being connected to the cooking cavity 10, and the first isolation port 43 being connected with a load.

According to the microwave oven provided by the embodiment, since the first isolator 40 is arranged between the microwave source 20 and the cooking cavity 10, the matching between the microwave source and the cooking cavity 10 is optimized, the first isolation port 43 of the first isolator 40 is connected with the load, and when amplified microwaves are reversely transmitted by the cooking cavity 10, the reversely transmitted microwaves will be consumed by the load connected with the first isolator 40, thereby avoiding the problem that the microwave source 20 is burnt out because the reversely transmitted microwaves are too large and guaranteeing the service life of the microwave source 20, and thus the product quality is improved.

Specifically, the load is a resistor 60, one end of the resistor 60 being electrically connected with the first isolation port 41, and the other end of the resistor being grounded; and a first feed-in device 11 is arranged on the cooking cavity 10, and the first output port 42 is communicated with the cooking cavity 10 through the first feed-in device 11.

The resistor 60 is small in volume and low in cost, occupies no internal space of the microwave oven and does not increase the production cost of the microwave oven, and moreover, the resistor 60 can effectively consume the microwaves reversely transmitted by the cooking cavity 10, thereby avoiding the problem that the microwave source 20 is burnt out because the reversely transmitted microwaves are too large, and guaranteeing the service life of the microwave source 20; and due to the arrangement of the microwave feed-in device, the connection between the isolator and the cooking cavity 10 is simple and convenient, and meanwhile, the transmission reliability of microwave signals is effectively guaranteed.

In the embodiment, preferably, the resistance of the resistor 60 is 50Ω.

Preferably, the first feed-in device 11 is welded or clamped or screwed on the cooking cavity 10.

The welding or clamping or screwing has good connection strength, so the connection strength of the feed-in device with the cooking cavity 10 is effectively guaranteed.

Optionally, the first feed-in device 11 is a probe or an antenna, and the antenna or the probe has the advantages of high efficiency, so the microwave transmission efficiency can be effectively improved.

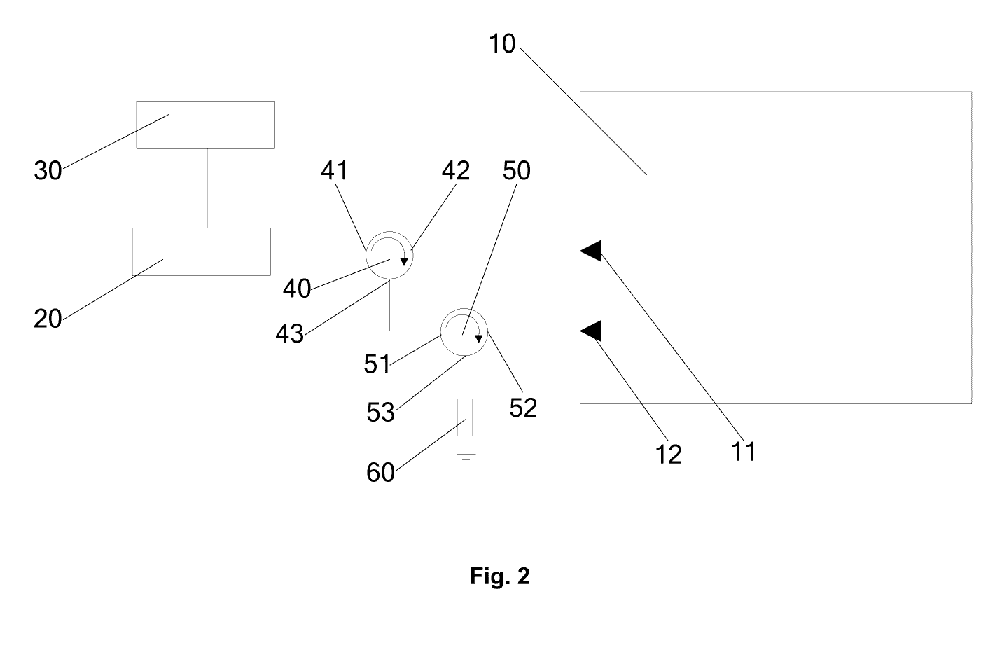

In a specific embodiment of the embodiment, as shown in FIG. 2, the microwave oven further includes a second isolator 50, wherein the second isolator 50 is provided with a second input port 51, a second output port 52 and a second isolation port 53, and a second feed-in device 12 is further arranged on the cooking cavity 10; the second input port 51 is connected to the first isolation port 43, the second output port 52 is communicated with the cooking cavity 10 through the second feed-in device 12, and one end of the resistor 60 is connected with the second isolation port 53.

The amplified microwaves are fed into the cooking cavity 10 after passing through the first isolator 40, at this time, the microwaves reversely transmitted by the cooking cavity 10 are fed into the cooking cavity 10 again by the second isolator 50, so the utilization rate of the microwaves is effectively improved, and the microwaves reversely transmitted by the cooking cavity 10 again are consumed by the resistor 60 connected with the isolation port of the second isolator 50, thereby effectively avoiding the problem that the microwave source 20 is burnt out because the reversely transmitted microwaves are too large, and guaranteeing the service life of the microwave source 20.

Preferably, the second feed-in device 12 is welded or clamped or screwed on the cooking cavity 10.

The welding or clamping or screwing has good connection strength, so the connection strength of the second feed-in device 12 with the cooking cavity 10 is effectively guaranteed.

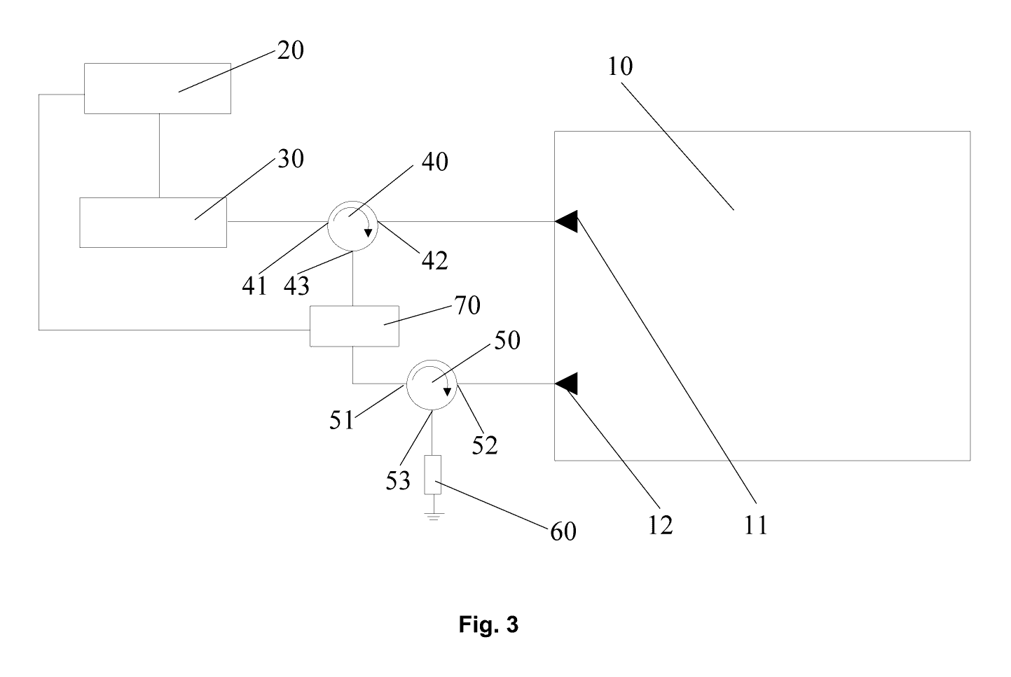

In another specific embodiment of the embodiment, as shown in FIG. 3, on the basis of the aforementioned embodiment, the microwave oven further includes a detector, which is connected with the first isolation port 43, for detecting microwave signal strength output by the first isolation port 43 and feeding back a detection result to the controller 30.

The detector detects the microwave signal strength output by the first isolation port 43 and sends the detection result to the controller 30, and the controller 30 adjusts the voltage or frequency or other parameter of the microwave source 20 according to the received detection result, so the matching between the microwave source 20 and the cooking cavity 10 is optimized.

Specifically, the detector includes a coupler, which is connected with the first isolation port 43.

In summary, according to the microwave oven provided by the present invention, the isolator is arranged between the microwave source and the cooking cavity, and the amplified microwaves are fed into the cooking cavity after passing through the isolator, so the matching between the microwave source and the cooking cavity is optimized, the isolation port of the isolator is connected with the load, and when the amplified microwaves are reversely transmitted by the cooking cavity, the reversely transmitted microwaves will be consumed by the load, and the microwave source and the reversely transmitted microwaves are effectively isolated, thereby avoiding the problem that the microwave source is burnt out because the reversely transmitted microwaves are too large and guaranteeing the service life of the microwave source, and thus the product quality is improved.

In the description of the present invention, the terms “first” and “second” are only for the purpose of description, but cannot be understood as indicating or implying relative importance, unless otherwise clearly specified and defined.

In the description of the present invention, the terms “installation”, “connection”, “connected” and the like should be understood broadly, for example, “connection” can be a fixed connection, can also be a detachable connection or an integral connection; “connected” can refer to a direct connection and can also be refer to an indirect connection by an intermediate medium. Those of ordinary skill in the art can understand the specific meanings of the aforementioned terms in the present invention in accordance with specific conditions.

In the description of the specification, the descriptions of the terms “one embodiment”, “some embodiments”, “ specific embodiment” and the like mean that specific features, structures, materials or characteristics described in conjunction with the embodiments or examples are contained in at least one embodiment or example of the present invention. In the specification, the schematic expression of the aforementioned terms does not necessarily refer to the same embodiment or example. Furthermore, the described specific features, structures, materials or characteristics can be combined in any one or more embodiments or examples in proper manners.

The foregoing descriptions are merely preferred embodiments of the present invention, and are not used for limiting the present invention. For those skilled in the art, the present invention can have various variations and modifications. Any modifications, equivalent substitutions, improvements and the like made within the spirit and principle of the present invention should be encompassed within the protection scope of the present invention.

1. A microwave oven, comprising:
a cooking cavity;
a microwave source;
a controller, which is connected to the microwave source, for controlling the power of the microwave source; and
a first isolator, which is provided with a first input port, a first output port and a first isolation port, the first input port being connected to the microwave source, the first output port being connected to the cooking cavity, and the first isolation port being connected with a load.

2. The microwave oven of claim 1, wherein the load is a resistor, one end of the resistor being electrically connected with the first isolation port, and the other end of the resistor being grounded.

3. The microwave oven of claim 2, wherein a first feed-in device is arranged on the cooking cavity, and the first output port is communicated with the cooking cavity through the first feed-in device.

4. The microwave oven of claim 3, further comprising:
a second isolator, wherein the second isolator is provided with a second input port, a second output port and a second isolation port, and a second feed-in device is further arranged on the cooking cavity; and
the second input port is connected to the first isolation port, the second output port is communicated with the cooking cavity through the second feed-in device, and one end of the resistor is connected with the second isolation port.

5. The microwave oven of claim 4, further comprising: a detector, which is connected with the first isolation port, for detecting microwave signal strength output by the first isolation port and feeding back a detection result to the controller.

6. The microwave oven of claim 5, wherein the detector comprises a coupler, which is connected with the first isolation port.

7. The microwave oven of claim 4, wherein both of the first feed-in device and the second feed-in device are welded or clamped or screwed on the cooking cavity.

8. The microwave oven of claim 7, wherein both of the first feed-in device and the second feed-in device are probes.

9. The microwave oven of claim 7, wherein both of the first feed-in device and the second feed-in device are antennas.

10. The microwave oven of claim 5, wherein both of the first feed-in device and the second feed-in device are welded or clamped or screwed on the cooking cavity.

11. The microwave oven of claim 10, wherein both of the first feed-in device and the second feed-in device are probes.

12. The microwave oven of claim 10, wherein both of the first feed-in device and the second feed-in device are antennas.

13. The microwave oven of claim 6, wherein both of the first feed-in device and the second feed-in device are welded or clamped or screwed on the cooking cavity.

14. The microwave oven of claim 13, wherein both of the first feed-in device and the second feed-in device are probes.

15. The microwave oven of claim 13, wherein both of the first feed-in device and the second feed-in device are antennas.
